(19) United States
(12) Patent Application Publication
(10) Pub. No.: US 2017/0089132 A1
(43) Pub. Date: Mar. 30, 2017

(54) Protective Screen Apparatus

(71) Applicants: Anzar Majidinazif, Rancho Cucamonga, CA (US); Madonna Zand, Rancho Cucamonga, CA (US)

(72) Inventors: Anzar Majidinazif, Rancho Cucamonga, CA (US); Madonna Zand, Rancho Cucamonga, CA (US)

(21) Appl. No.: 15/281,033

(22) Filed: Sep. 29, 2016

Related U.S. Application Data
(60) Provisional application No. 62/235,294, filed on Sep. 30, 2015.

(51) Int. Cl. E06B 9/54; E06B 9/40; E06B 9/58

(52) U.S. Cl. CPC E06B 9/54; E06B 9/58; E06B 9/40

(57) ABSTRACT

A protective screen apparatus for selectively covering a doorway is provided. The doorway has a right side and a left side. The protective screen apparatus comprises a roll screen housing mountable over the doorway with the roll screen housing having a first end and a second end. A roll of screen material mounted within the roll screen housing with the screen material capable of covering at least a portion of the doorway. The screen material has a first side edge and a second side edge. An opening is formed in the roll screen housing for allowing the screen material to exit the roll screen housing to cover at least a portion of the doorway and to re-enter the roll screen housing to completely uncover the doorway. The protective screen apparatus provides a simple and convenient means of enjoying an outdoor breeze while saving money in energy costs.

### CLAIM OF PRIORITY

This patent application claims priority under 35 USC 119 (e) (1) from U.S. Provisional Patent Application Ser. No. 62/235,294 filed Sep. 30, 2015, of common inventorship herewith entitled, “Magic Screen,” which is incorporated herein by reference as though the same were set forth in its entirety.

### FIELD OF THE INVENTION

The present invention pertains to the field of door treatments, and more specifically to the field of protective screens.

### BACKGROUND OF THE INVENTION

At the first sign of a warm spring breeze after winter months, it is common to see many homes with windows and doors ajar to allow invigorating air to flow freely through the house. Whether basking in the warmth of the outside, breathing fresh air into the lungs or relaxing to a cacophony of nature sounds, throwing open a window or front door is a favored way to savor the outside elements while still remaining inside a house. Those individuals who enjoy a refreshing breeze while indoors typically have screen doors installed at the front entranceway of the home. These convenient barriers allow air to enter the home unencumbered while also serving as an effective shield against insects entering the home. Rustic screen doors also lend a charming ambiance to the facade of any home. Many domestic dwellers are unable to enjoy simple luxuries that screen doors provide. Particularly, residents in rental homes, rental apartments and planned communities often are unable to mar another owner's structure or deviate from firm construction guidelines by installing a permanent screen door. Such residents cannot keep their front doors open for extended periods of time due to potential invasion by insects and other pests.

The prior art has put forth several designs for protective screens. Among these are:

U.S. Pat. No. 4,651,797 to Al E. Lange describes a rollup screen door including a long, narrow housing having a length adapted to extend vertically for the full height of a door casement opening. The housing contains a conventional spring biased roll upon which is initially wound a large sheet of flexible screen material, one end of which is secured to the roll so the screen material can be unwound from the roll against the tension of the roll. When the housing is mounted adjacent to one side of the vertical trim strip along one side of the door casement opening, the screen material passes through a longitudinal exit slot in the housing in a plane located inwardly of the front face of the vertical trim strip, so that the screen material sealingly engages the adjacent vertical trim strip when it is stretched across the door opening. The front vertical edge portion of the sheet of screen material extends into and is anchored within a vertical groove formed in the inner end of a main curved body portion of a sealing and anchoring strip which extends for the full height of the door opening. The sealing and anchoring strip has extending inwardly of opposite sides of the sheet of screen material handle forming projections which can be gripped when the sheet of screen material is in its door covering position. The main body portion of the strip has a slot which receives an anchoring pin extending from one of the vertical trim strips. The curved body portion of the strip is held in sealing engagement with the latter vertical trim strip by this anchoring pin.

U.S. Pat. No. 3,882,921 to Sandall Ronald Ernest describes a roller screen assembly for an aperture. The assembly includes a spring returned roller and a flexible glazing screen wound thereon. Also included is a headboard and sealing member closing a gap between the screen and the headboard. The assembly further includes a bottom strip adapted to engage the lower edge of the screen and to temporarily retain the same. Side channels, which receive the lateral edges of the screen, extend from the headboard to the bottom strip at each side of the screen. The headboard, bottom strip and side channel form a frame for the screen when in its extended position.

U.S. Pat. No. 1,595,234 to Peter H. Kuyper describes a tubular roller and screen secured thereto with the roller containing a shaft there within. A coil spring on the shaft is connected at one end with the shaft and at the other end with the roller. A casing for the roller has a slot through which the screen may pass. The ends of the casing having curved slots through which the shaft extends. Rods connect with the ends of the shaft and are pivotally supported at points spaced from the line of the axis of the shaft, whereby tension of the spring tends to swing the shaft on such pivots away from the extended plane of the path of travel of the screen through the slot.

None of these prior art references describe the present invention.

### SUMMARY OF THE INVENTION

It is an object of the present invention to provide a remotely controlled automatic screen door that is particularly configured to fit in an interior entranceway to a home at the top of the doorframe.

The present invention is a protective screen apparatus for selectively covering a doorway. The doorway has a right side and a left side. The protective screen apparatus comprises a roll screen housing mountable over the doorway with the roll screen housing having a first end and a second end. A roll of screen material mounted within the roll screen housing with the screen material capable of covering at least a portion of the doorway. The screen material has a first side edge and a second side edge. An opening is formed in the roll screen housing for allowing the screen material to exit the roll screen housing to cover at least a portion of the doorway and to re-enter the roll screen housing to completely uncover the doorway. The protective screen apparatus provides a simple and convenient means of enjoying an outdoor breeze while saving money in energy costs.

In addition, the present invention includes a method for selectively covering a doorway. The doorway has a right side and a left side. The method comprises mounting a roll screen housing over the doorway with the roll screen housing having a first end and a second end, mounting a roll of screen material within the roll screen housing, forming an opening in the roll screen housing for allowing the screen material to exit the roll screen housing to cover at least a portion of the doorway and to re-enter the roll screen housing to completely uncover the doorway, covering at least a portion of the doorway, and providing a simple and convenient means of enjoying an outdoor breeze while saving money in energy costs.

The present invention further includes a protective screen apparatus for selectively covering a doorway. The doorway has a right side and a left side. The protective screen apparatus comprises a roll screen housing mountable over the doorway with the roll screen housing having a first end and a second end. A roll of screen material is mounted within the roll screen housing with the screen material capable of covering at least a portion of the doorway and the screen material having a first side edge and a second side edge. A first screen guide is mounted along the right side of the doorway with the first side edge of the screen material slidably receivable within the first screen guide. A second screen guide is mounted along the left side of the doorway, the second side edge of the screen material receivable within the second screen guide. An opening is formed in the roll screen housing for allowing the screen material to exit the roll screen housing to cover at least a portion of the doorway and to re-enter the roll screen housing to completely uncover the doorway. A remote control alternatingly unrolls the screen material from and rolls the screen material into the roll screen housing. The protective screen apparatus provides a simple and convenient means of enjoying an outdoor breeze while saving money in energy costs.

### BRIEF DESCRIPTION OF THE DRAWINGS

FIG. 1 is a perspective view illustrating a protective screen apparatus, constructed in accordance with the present invention, with a screen in a rolled up position and a roll screen housing for receiving the screen located above the door frame with screen guides mounted along each side of the doorway.

FIG. 2 is a perspective view illustrating the protective screen apparatus, constructed in accordance with the present invention, with the screen in a partially rolled down position and the roll screen housing located above the door frame with screen guides mounted along each side of the doorway.

FIG. 3 is a perspective view illustrating the protective screen apparatus, constructed in accordance with the present invention, with the screen in a rolled down position and the roll screen housing located above the door frame with screen guides mounted along each side of the doorway.

FIG. 4 is a perspective view illustrating a remote control component of the protective screen apparatus, constructed in accordance with the present invention, with the remote control component used to raise and lower the screen from afar.

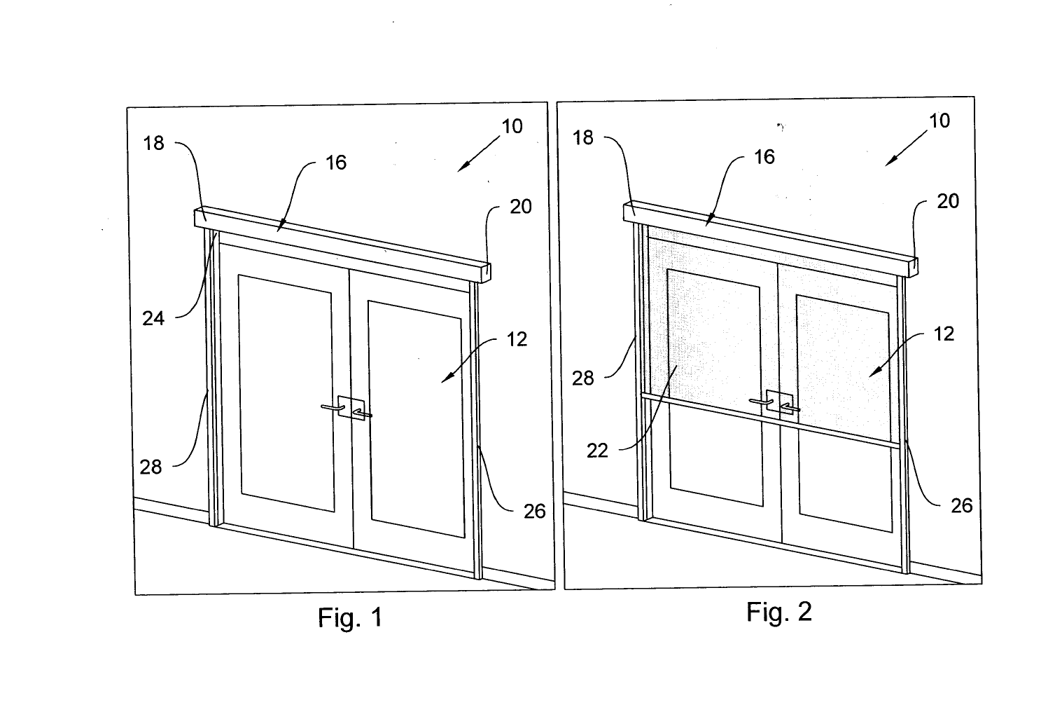

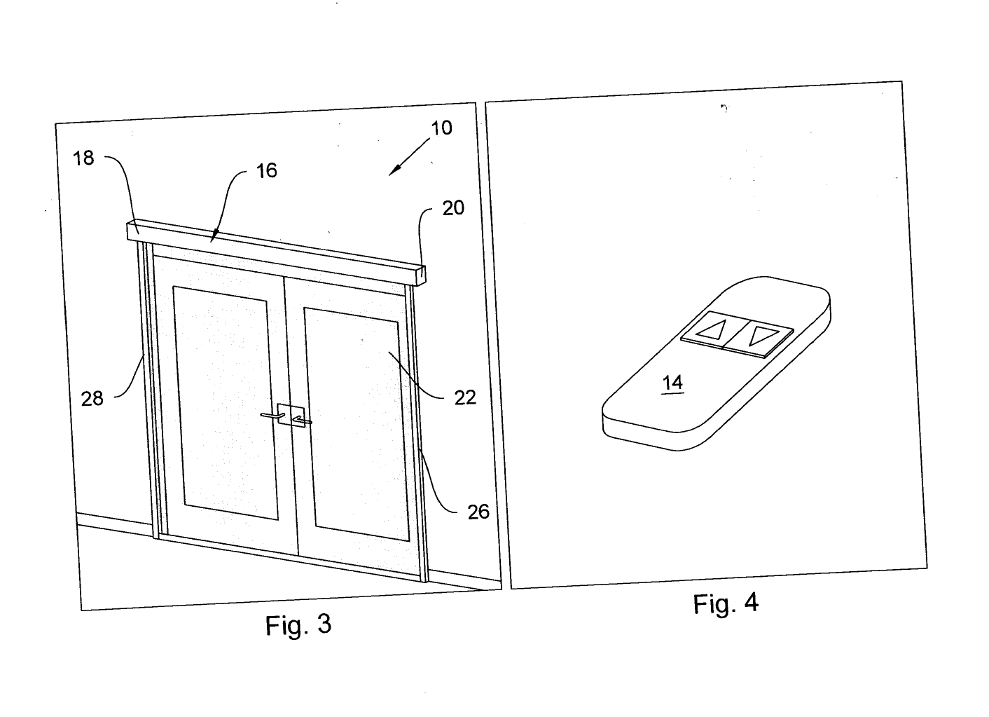

### DETAILED DESCRIPTION OF THE INVENTION

The present invention, hereinafter referred to as the Protective Screen Apparatus 10, is a remotely controlled automatic screen door that is particularly configured to fit in an interior entranceway to a home at the top of a doorway 12. The Protective Screen Apparatus 10 provides a simple and convenient means of enjoying an outdoor breeze by means of using a screen door while saving money in energy costs. Easily and unobtrusively installed and removed as needed, the Protective Screen Apparatus 10 preferably functions by means of a remote control 14, providing a hands free operation whenever one wishes to keep the door 12 open.

The Protective Screen Apparatus 10 comprises a roll screen housing 16 mountable over the doorway 12. The roll screen housing 16 has a first end 18 and a second end 20 with, in a preferred embodiment, the first end 18 extending beyond one side of the doorway 12 and the second end 20 extending beyond the other side of the doorway 12. The roll screen housing 16 is preferably constructed of heavy duty metal or wood material although constructing the roll screen housing 16 can be constructed from other durable materials. In addition, the roll screen housing 16 can be constructed in a variety of lengths with a standard assembly to accommodate doorways 12 of various sizes. To facilitate attachment of the roll screen housing 16 to the frame above the doorway 12, Protective Screen Apparatus 10 can contain a series of screws or other fastening mechanisms equipped with jamb shields.

The Protective Screen Apparatus 10 of the present invention further includes a roll of screen material 22 mounted in the roll screen housing 16. The screen material 22 is unrollable from the roll screen housing 16 through a slot 24 or other opening formed in the roll screen housing 16 to partially or completely cover the doorway 12. The screen material 22 is preferably an ultrafine configuration up to approximately one hundred thirty two holes per square inch although any type of screen material 22 is within the scope of the present invention.

In addition, the Protective Screen Apparatus 10 of the present invention includes a pair of screen guides with a first screen guide 26 mounted along a right side of the doorway 12 and a second screen guide 28 mounted along a left side of the doorway 12. The first screen guide 26 is preferably substantially parallel to the second screen guide 26 and substantially perpendicular to the roll screen housing 16. The screen guides 26, 28 are shaped and sized for receiving edges of the screen material 22 as the screen material travels within the screen guides 26, 28.

Furthermore, the Protective Screen Apparatus 10 of the present invention includes the remote control 14 for alternatingly unrolling the screen material 22 from and rolling the screen material 22 into the roll screen housing 16. An electronic receiver circuit with a tuned frequency is encased within the roll screen housing 16 of the Protective Screen Apparatus. Functioning as a transmitter of operations for the Protective Screen Apparatus 10, the independent remote control device 14 is preferably rectangular in shape and contains simple directives such as Up and Down. The interior components of the remote control 14 are comprised of a frequency generator, amplifier, internal antenna, and required electrical and electronic components and circuitry, which are all encased within a durable plastic housing. The receiver and transmitter of the Protective Screen Apparatus 10 are internally powered by an AA alkaline battery. The Protective Screen Apparatus 10 is produced in a variety of colors to appeal to various personal tastes or match an existing decorating, motif.

Using the Protective Screen Apparatus 10 is simple and straightforward. A user selects and purchases an appropriately sized Protective Screen Apparatus 10. The user mounts the roll screen housing 16 and the screen guides 26, 28 of the Protective Screen Apparatus 10 above and around the doorway 12 within a few minutes. Operated by the remote control 14, the user raises or lowers the screen material 22 of the Protective Screen Apparatus 10 from any vantage point whether lounging in a recliner or preparing to cook the evening meal.

Without blemishing a permanent doorway, residents can keep their doors open for as long as they wish without worry of pesky, disease carrying insects entering the house. Natural air can flow through the house without constantly running air conditioning units. The Protective Screen Apparatus 10 also is effectively functional in public buildings, business establishments and restaurants. Constructed from high quality and durable materials, the Protective Screen Apparatus 10 will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A protective screen apparatus for selectively covering a doorway, the doorway having a right side and a left side, the protective screen apparatus comprising:
a roll screen housing mountable over the doorway, the roll screen housing having a first end and a second end;
a roll of screen material mounted within the roll screen housing, the screen material capable of covering at least a portion of the doorway, the screen material having a first side edge and a second side edge; and
an opening formed in the roll screen housing for allowing the screen material to exit the roll screen housing to cover at least a portion of the doorway and to re-enter the roll screen housing to completely uncover the doorway;
wherein the protective screen apparatus provides a simple and convenient means of enjoying an outdoor breeze while saving money in energy costs.

2. The protective screen apparatus of claim 1 wherein the first end of the roll screen housing extends beyond a right side of the doorway and the second end of the roll screen housing extends beyond the left side of the doorway.

3. The protective screen apparatus of claim 1 wherein the roll screen housing is constructed of a material selected from metal and wood.

4. The protective screen apparatus of claim 1 and further comprising:
at least one fastening mechanism for releasably securing the roll screen housing above the doorway.

5. The protective screen apparatus of claim 1 wherein the opening formed in the roll screen housing is a slot having a length slightly larger than a width of the screen material.

6. The protective screen apparatus of claim 1 wherein screen is an ultrafine configuration up to approximately one hundred thirty two holes per square inch.

7. The protective screen apparatus of claim 1 and further comprising:
a first screen guide mounted along the right side of the doorway, the first side edge of the screen material slidably receivable within the first screen guide; and
a second screen guide mounted along the left side of the doorway, the second side edge of the screen material receivable within the second screen guide.

8. The protective screen apparatus of claim 7 wherein the first screen guide is substantially parallel to the second screen guide.

9. The protective screen apparatus of claim 8 wherein the first screen guide and the second screen guide are substantially perpendicular to the roll screen housing.

10. The protective screen apparatus of claim 1 and further comprising:
a remote control for alternatingly unrolling the screen material from and rolling the screen material into the roll screen housing.

11. The protective screen apparatus of claim 10 and further comprising:
an electronic receiver circuit with a tuned frequency encased within the roll screen housing.

12. The protective screen apparatus of claim 10 wherein the remote control device is rectangular in shape and contains simple directives such as Up and Down.

13. A method for selectively covering a doorway, the doorway having a right side and a left side, the method comprising:
mounting a roll screen housing over the doorway, the roll screen housing having a first end and a second end;
mounting a roll of screen material within the roll screen housing;
forming an opening in the roll screen housing for allowing the screen material to exit the roll screen housing to cover at least a portion of the doorway and to re-enter the roll screen housing to completely uncover the doorway;
covering at least a portion of the doorway; and
providing a simple and convenient means of enjoying an outdoor breeze while saving money in energy costs.

14. A protective screen apparatus for selectively covering a doorway, the doorway having a right side and a left side, the protective screen apparatus comprising:
a roll screen housing mountable over the doorway, the roll screen housing having a first end and a second end;
a roll of screen material mounted within the roll screen housing, the screen material capable of covering at least a portion of the doorway, the screen material having a first side edge and a second side edge;
a first screen guide mounted along the right side of the doorway, the first side edge of the screen material slidably receivable within the first screen guide;
a second screen guide mounted along the left side of the doorway, the second side edge of the screen material receivable within the second screen guide;
an opening formed in the roll screen housing for allowing the screen material to exit the roll screen housing to cover at least a portion of the doorway and to re-enter the roll screen housing to completely uncover the doorway; and
a remote control for alternatingly unrolling the screen material from and rolling the screen material into the roll screen housing;
wherein the protective screen apparatus provides a simple and convenient means of enjoying an outdoor breeze while saving money in energy costs.

15. The protective screen apparatus of claim 14 wherein the first end of the roll screen housing extends beyond a right side of the doorway and the second end of the roll screen housing extends beyond the left side of the doorway.

16. The protective screen apparatus of claim 14 and further comprising:
at least one fastening mechanism for releasably securing the roll screen housing above the doorway.

17. The protective screen apparatus of claim 14 wherein the opening formed in the roll screen housing is a slot having a length slightly larger than a width of the screen material.

18. The protective screen apparatus of claim 14 wherein the first screen guide is substantially parallel to the second screen guide.

19. The protective screen apparatus of claim 18 wherein the first screen guide and the second screen guide are substantially perpendicular to the roll screen housing.

20. The protective screen apparatus of claim 14 and further comprising:
an electronic receiver circuit with a tuned frequency encased within the roll screen housing.
